(19) United States
(12) Patent Application Publication
(10) Pub. No.: US 2005/0280756 A1
(43) Pub. Date: Dec. 22, 2005

(54) Blacklight assembly and display device having the same

(75) Inventors: Heu-Gon Kim, Gyeonggi-do (KR); Hea-Chun Lee, Gyeonggi-do (KR); Jae-Ho Jung, Gyeonggi-do (KR); Ju-Hwa Ha, Seoul (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/097,816

(22) Filed: Mar. 31, 2005

(30) Foreign Application Priority Data
Jun. 21, 2004 (KR) 2004-46224

(51) Int. Cl. G02F 1/1335

(52) U.S. Cl. 349/114

(57) ABSTRACT

A compact, light, and uniformly bright backlight assembly and a display device are disclosed. The backlight assembly includes a light source assembly, a substrate, and a transflective member. The light source assembly emits a first light with a first luminance uniformity. Then, the first light passes through the substrate above the light source assembly for producing enhanced luminance uniformity. Again, after the light is reflected from and/or transmitted through the transflective member, the luminance uniformity is even more enhanced. Therefore, the volume, weight, and luminance uniformity of the backlight assembly and the display device are enhanced.

### RELATED APPLICATIONS

This application claims the benefit and priority of Korean Patent Application Serial No. 10-2004-0046224, filed Jun. 21, 2004, which is incorporated herein by reference in its entirety.

### TECHNICAL FIELD

The present invention relates to a liquid crystal display (LCD) and, more particularly, to a LCD with a backlight assembly.

### BACKGROUND

A backlight assembly is used as a source of light for passive displays such as liquid crystal display (LCD). Conventionally, light emitting diode (LED), cold cathode fluorescent lamp (CCFL), and flat fluorescent lamp (FFL) are the light sources for backlight assembly.

Commonly, the CCFL and FFL are used for a large LCD while the LED is used for a small LCD. Even though LEDs are superior in luminescence and energy consumption to CCFLs and FFLs, LEDs are typically not used for a large LCD because of low luminance uniformity. In addition, an LED matrix requires a backlight assembly that is bulky in order to obtain uniform high luminescence and low energy consumption.

Accordingly, there has been a need for a backlight assembly and a LCD which are compact and light while improving luminance uniformity.

### SUMMARY

A backlight assembly, in accordance with an embodiment of the present invention, may include a light source assembly, a substrate, and a light transflective member. The light source assembly emits a first light with a first luminance uniformity. The substrate is disposed above the light source assembly for modifying the first light trajectory and for emitting a second light with a second luminance uniformity, more uniform than the first luminance uniformity. The transflective member is disposed on or above the substrate to emit a third light with a third luminance uniformity, enhanced from the second luminance uniformity, by reflecting a portion of the second light.

A display device, in accordance with an embodiment of the present invention, includes a backlight assembly and a display panel. The backlight assembly may include a light source assembly, a substrate, and a transflective member. The light source assembly emits a first light with a first luminance uniformity. The substrate is disposed above the light source assembly for modifying the first light trajectory and for emitting a second light with a second luminance uniformity, more uniform than the first luminance uniformity. The transflective member is disposed on or above the substrate to emit a third light with a third luminance uniformity, enhanced from the second luminance uniformity, by reflecting a portion of the second light. The display panel displays image by using the third light of the backlight assembly.

According to the present invention, the size, the weight, and the luminance uniformity of the backlight and display device are improved.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is an exemplary diagram of a backlight assembly in accordance with a first embodiment of the present invention.

FIG. 2 is a luminance uniformity graph of a luminance between the light sources and the substrate of the FIG. 1.

FIG. 3 is an exemplary diagram of a backlight assembly in accordance with a second embodiment of the present invention.

FIG. 4 is an exemplary diagram of a backlight assembly in accordance with a third embodiment of the present invention.

FIG. 5 is a luminance uniformity graph of a light guiding lens of the FIG. 4.

FIG. 6 is an exemplary diagram of a backlight assembly in accordance with a fourth embodiment of the present invention.

FIG. 7 is a magnified “A” portion of the FIG. 1 in accordance with a fifth embodiment of the present invention.

FIG. 8 is an exemplary diagram of a backlight assembly in accordance with a sixth embodiment of the present invention.

FIG. 9 is an exemplary diagram of a backlight assembly in accordance with a seventh embodiment of the present invention.

FIG. 10 is an exemplary diagram of a backlight assembly in accordance with a eighth embodiment of the present invention.

FIG. 11 is an exemplary diagram of a backlight assembly in accordance with a ninth embodiment of the present invention.

FIG. 12 is a luminance uniformity graph of a backlight assembly with different distances between a reflector and an optical member when no transflective member present according to the ninth embodiment of the present invention.

FIG. 13 is a plain view of luminance uniformity on the optical member of the FIG. 12.

FIG. 14 is a luminance uniformity graph of a backlight assembly with different distances between a reflector and an optical member when a transfiective member is present according to the ninth embodiment of the present invention.

FIG. 15 is a plain view of luminance uniformity on the optical member of the FIG. 14.

FIG. 16 is an exemplary diagram of a backlight assembly in accordance with a tenth embodiment of the present invention.

### DETAILED DESCRIPTION

Embodiment I

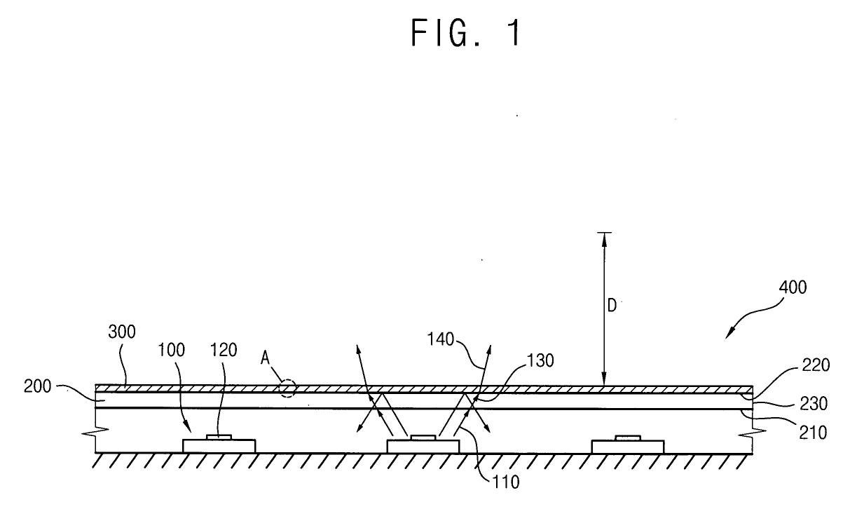

FIG. 1 is an exemplary diagram of a backlight assembly in accordance with a first embodiment of the present invention. A backlight assembly 400 includes a light source assembly 100, a substrate 200, and a transflective (or transreflective) member 300. The light source assembly 100 is disposed under both of the substrate 200 and the transflective member 300 for providing a first light 110 to the substrate 200 and the transflective member 300. The light source assembly 100 includes a light source 120 for providing the first light 110. Throughout the embodiments of the present invention, the light source 120 may be, but is not limited to, a light emitting diode LED which emits either white light or colored light such as red, green and blue light. For mixing the first light at the upper portion of the substrate 200, the light source 120 may be inclined relative to the surface of the substrate 200.

A plurality of light sources 120 may be arranged in matrix form for better first luminance uniformity.

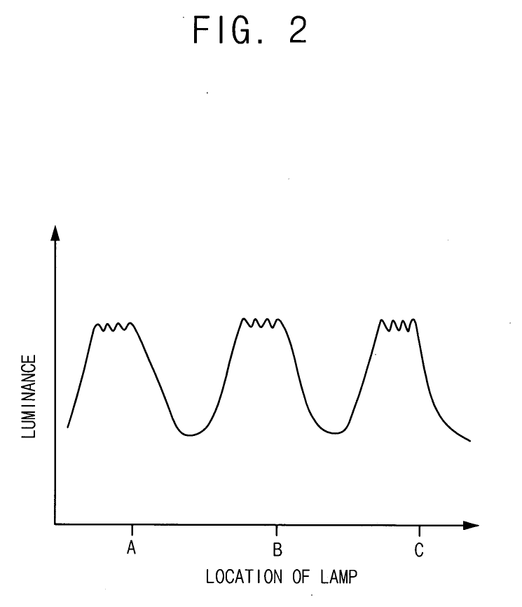

FIG. 2 is a luminance uniformity graph of a luminance between the light sources 120 and the substrate 200 of the FIG. 1. In FIG. 2, the X axis is the location of the light sources 120 (represented by letters A, B, and C); the Y axis is the brightness of each of the light sources A, B, and C. In other words, FIG. 2 shows three light sources, each spaced a distance apart from each other. The distance along the x-axis is the distance away from the light source. So, looking at A, one sees that as the distance from A increases (to either side of A), the luminance or brightness decreases until the distance to another light source, such as B, approaches.

When light sources 120 (A, B, C) are turned on, the first luminance uniformity is very low (very non-uniform brightness along the x-axis), as shown in FIG. 2. The reason is that the luminance at the point above the light sources 120 is higher than at the point of the gaps of the light sources 120. Accordingly, for enhancing the first luminance uniformity, the substrate 200 should be placed apart from and above the light sources 120.

The substrate may include a first surface 210 which faces the light source assemblies 100, a second surface 220 which faces the first surface 210, and lateral surfaces 230 which connect the first surface 210 and the second surface 220. The substrate 200 has a light transmitting condition, such as a critical angle for reflection, such that a portion of the first light 110 is transmitted, while the other portion of the first light 110 is reflected. As used herein, “transmit” does not necessarily mean actively transmit. “Transmit” can mean that the light is simply passed through the material or substrate.

Hereinafter, a second light 130 is defined as the light transmitted through the first surface 210 of the substrate 200. The second light 130 has better luminance uniformity than the first light 110. The second light 130 is mixed by itself within the substrate 200, especially near the second surface 220 of the substrate 200; therefore, even with the different colors of red, green, and blue first light 110, the second light 130 becomes white light by being mixed within the substrate 200.

However, because the first light 110 enters into the substrate 200 in an oblique line, an additional space is needed for mixing the second light 130 within the substrate 200, especially near the second surface 220 of the substrate 200. The thickness of the substrate is at least 40mm in height in one embodiment.

Throughout the embodiments of the present invention, for diminishing the additional space and enhancing the luminance uniformity of the second light 130, a transflective member 300 reflects a portion of the second light 130 and transmits the remains of the second light 130. As used herein, “transflective” means having the characteristic of both reflecting and transmitting (or passing) light. The transflective member 300 may be made from different material from the substrate and have a different refractive index to accommodate enhanced luminance uniformity. For instance, the refractive index of the transflective member 300 can be smaller than the refractive index of the substrate so as to effectively transmit and reflect the second light.

The transflective member 300 is disposed near the substrate 200. For example, the transflective member 300 is disposed on or above the second surface 220 of the substrate 200 and changes the second light 130 to the third light 140 which is superior in luminance uniformity to the second light 130.

On the other hand, the transflective member 300 can be disposed near, for example on or below, the first surface 210 of the substrate 200 or both of the first surface 210 and the second surface 220 of the substrate 200 to enhance the uniformity of the backlight. For emitting highly uniform luminescence, the transflective member 300 near either the first surface 210 and/or the second surface 220 reflects a portion of the second light 130 and/or the first light 110 back towards the light source assembly 100 and receives the rebounded second light 130 and/or the first light 110 from the light source assembly 100 side.

Embodiment II

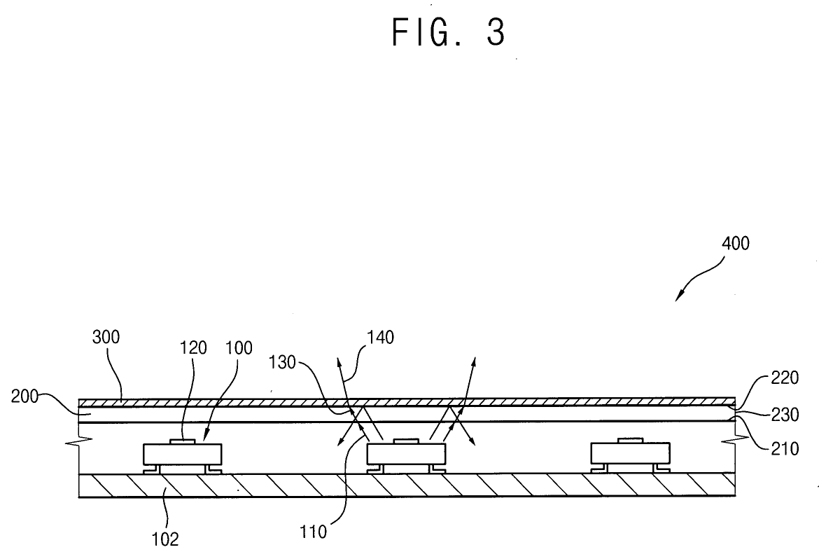

FIG. 3 is an exemplary diagram of a backlight assembly in accordance with a second embodiment of the present invention. Except for an electrical power impression board, the backlight assembly is the same with the first embodiment; therefore, the same numerical references are used for the same member of the backlight assembly, and duplicated descriptions are omitted.

The light source assembly 100 of the present invention includes an electrical power impression board 102 which transmits electronic signals from an external apparatus (not shown) to the light sources 120 for generating the first light 110. For example, the electrical power impression board 102 may be a printed circuit board (PCB) with embedded conductive patterns and affixed to light source assemblies 100. Furthermore, the light source assemblies may be arranged in matrix form.

Embodiment III

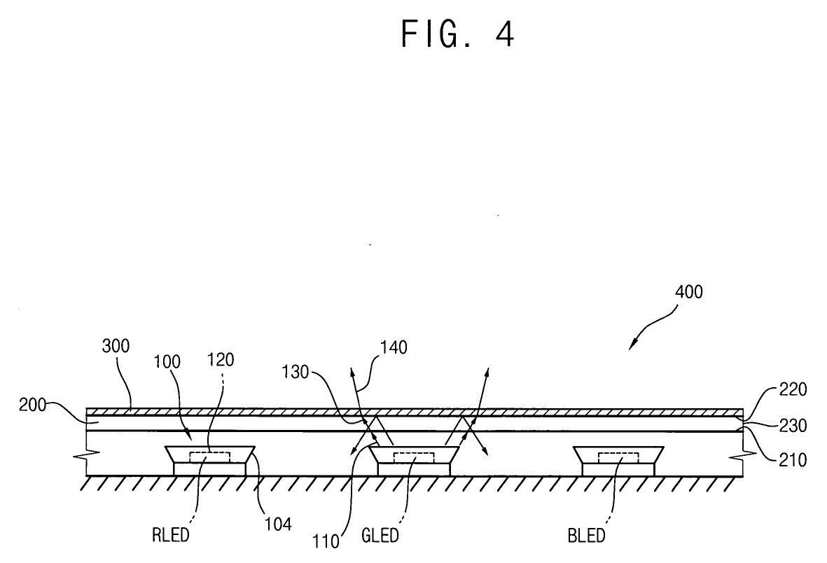

FIG. 4 is an exemplary diagram of a backlight assembly in accordance with a third embodiment of the present invention. Except for a light guiding lens, the backlight assembly is the same with the first embodiment of the present invention. Hence, the same numerical references are used for the same member of the backlight assembly, and duplicated descriptions are omitted.

The light sources 120 of the light source assemblies 100 emit red, green, and blue light, respectively, which are later changed to white light by being mixed within the substrate 200, especially near the second surface 202. Each light source 120 can be a red light emitting diode RLED, a green light emitting diode GLED, or a blue light emitting diode BLED.

A light guiding lens 104 is disposed on each of the light source assemblies 100 for guiding light into the substrate 200, where the light is mixed. For improved light mixing, the light guiding lens is designed to guide the first light 110 to a certain range of angle θ, for example the angle of 70° to 90° from the surface of the substrate.

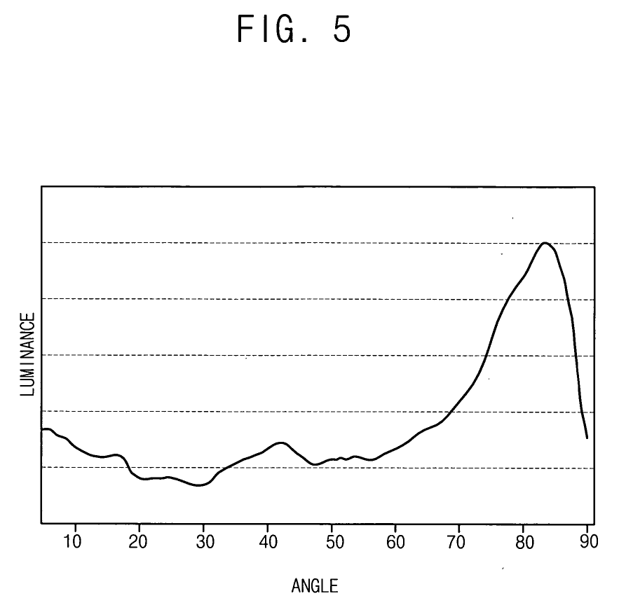

FIG. 5 is a luminance uniformity graph of the light guiding lens of the FIG. 4. The x-axis is the angle of the light as it enters substrate, and the y-axis is the brightness of the light as it exits. As shown in FIG. 5, with the light guiding lens 104, brightness is greatly enhanced when the light guiding lens 104 guides the light to an angle between 70° and 90°. After entering to the substrate, the second light is widely spread and mixed by itself within the substrate.

Embodiment IV

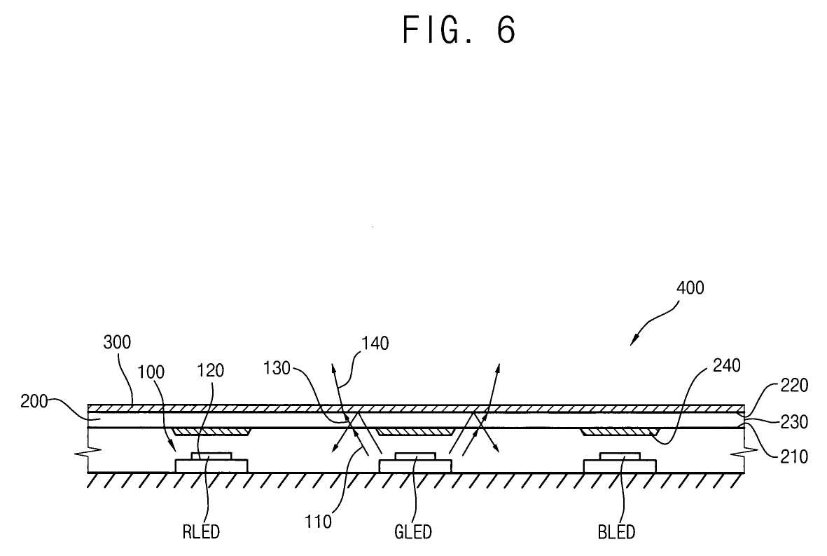

FIG. 6 is an exemplary diagram of a backlight assembly in accordance with a fourth embodiment of the present invention. Except for a light block, the backlight assembly is the same with the first embodiment of the present invention. Therefore, the same numerical references are used for the same member of the backlight assembly, and duplicated descriptions are omitted.

Each of the light sources 120 emits a red, green, or blue light which is mixed within the substrate 200 and become a white light as a whole. Each light source 120 can be a red light emitting diode RLED, a green light emitting diode GLED, or a blue light emitting diode BLED. To help mix the red, green, and blue first lights within the substrate 200, a light block 240 is disposed on the substrate 200. The light blocks 240 are designed to allow only light within a certain angle, for example 70° to 90° measured from the first surface 210 of the substrate, to enter the substrate 200.

The light blocks 240 may be disposed on the first surface 210 to be exposed to the first light 110. Also, the light blocks 240 may be a thin film layer of light reflecting material and located as the first light 210 can enter into the substrate 200 within a certain range of angle, for example the angle of 70° to 90° to the first surface 210 of the substrate 200.

Furthermore, light blocks 240 on the substrate 200 and light guiding lens 104 on the light sources 120 can be used together.

Embodiment V

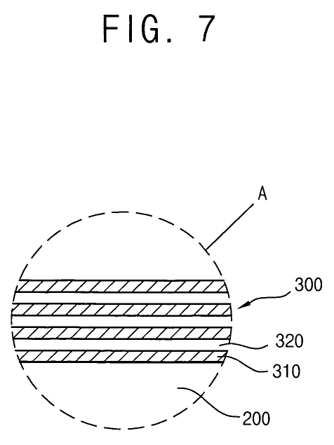

FIG. 7 is a magnified view of portion “A” of the transflective member 300 of FIG. 1 in accordance with a fifth embodiment of the present invention.

Referring to FIG. 1 and FIG. 7, the transflective member 300 includes light reflective layers 310 and light transmitting layers 320 which may be formed alternatively on the substrate 200. For having the best luminance uniformity and the luminescence of the third light, the number and/or the thickness of the reflective and transmitting layers 310, 320 may be determined by the luminance uniformity and the luminescence of the second light 130.

Having constant brightness of the first light 110, the transmitted second light luminance decreases as the reflected second light luminance increases and vice versa. Accordingly, for example, when the portion of the reflected second light luminance is 10 to 90 percent, then the portion of the transmitted second light luminance is substantially 90 to 10 percent. In other words, the luminance of the reflected second light and transmitted second light have a reciprocal or inverse relationship. For example, when the second light luminance reflected from the transflective member is 70 percent, the second light luminance transmitted or passed through by the transflective member is approximately 30 percent.

Thus, by controlling the reflection and transmission ratio of the transfiective member 300, the third luminance uniformity of the third light 140 can be enhanced from the second luminance uniformity of the second light 130. As a result, the enhanced third luminance uniformity can be used in reducing the light mixing space and the total volume of the backlight assembly

Embodiment VI

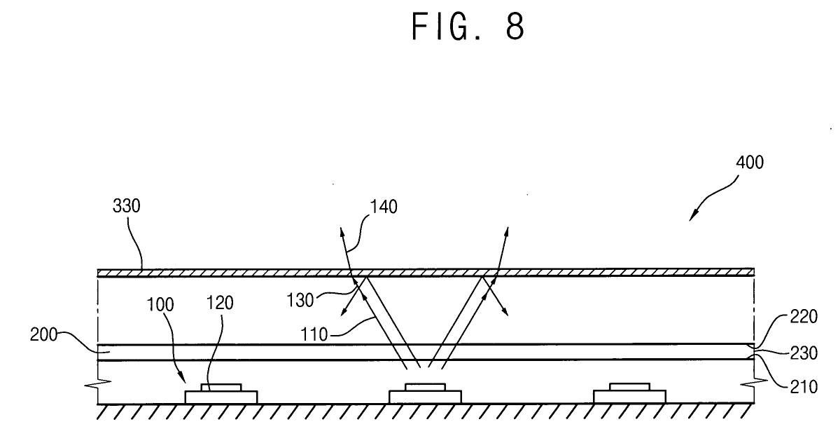

FIG. 8 is an exemplary diagram of a backlight assembly in accordance with a sixth embodiment of the present invention. Except for the transflective film, the backlight assembly is the same with the first embodiment of the present invention. Therefore, the same numerical references are used for the same member of the backlight assembly, and duplicated descriptions are omitted.

A transflective film 300 can be made in either flexible film type or rigid plate type. In this embodiment, the transflective film 330 is disposed on the second surface 220 of the substrate 200. The transflective film 330 transmits a portion of the second light 130 and reflects substantially the remaining portion of the second light 130. Thus, the luminance uniformity of the third light 140 is enhanced from that of the second light 130, and therefore, the space for mixing the third light 140, the total volume, and the weight of the whole backlight assembly can be reduced.

Alternatively, the transflective film 330 of the present invention can be disposed between the substrate 200 and the light source assembly 100, be disposed on the first surface 210 of the substrate 200 that faces the light source assembly, or be disposed on both of two sides 210, 220 of the substrate.

Because the transfiective member 300 is film 330, disposing on and eliminating from the substrate 200 are very easy. Therefore, the controlling the brightness and luminance uniformity or the second and third lights 130, 140 are very convenient to the manufacturer.

Embodiment VII

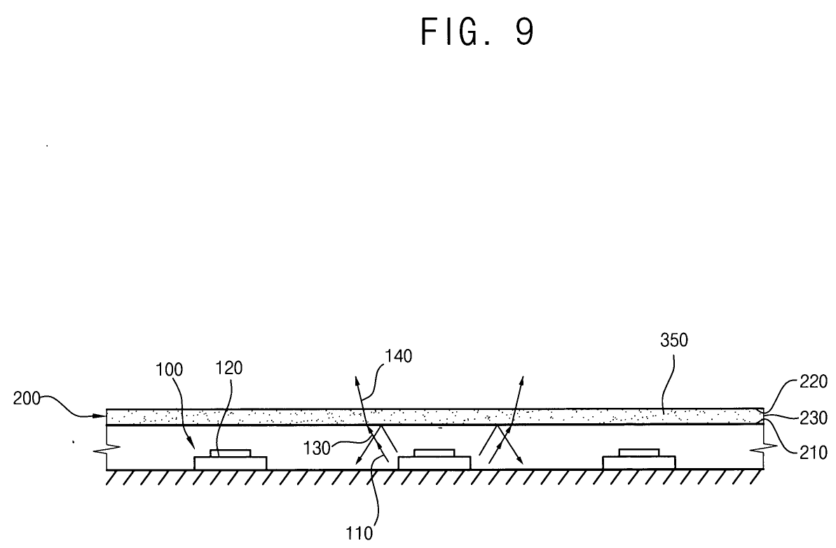

FIG. 9 is an exemplary diagram of a backlight assembly in accordance with a seventh embodiment of the present invention. Except for the transflective member and the substrate 200, the backlight assembly is the same with the first embodiment of the present invention. Therefore, the same numerical references are used for the same member of the backlight assembly, and duplicated descriptions are omitted.

In this embodiment, the transflective member 300 of FIG. 1 is located inside of the substrate 200 for reflecting a portion of the second light 130. The transflective member 300 may be particles 350, e.g., highly reflective tiny metal beads, those reflect a portion of the second light 130.

Besides being included in the substrate 200, the particles 350 can be mixed with a material such as a binder to form a substrate, where the substrate can be included as a separated plate which is disposed on either first or second surface 210, 220 of the substrate 200.

As a result, the transfiective member 350 enhances the luminance uniformity within the substrate 200 by partially transmitting the second light 130 and partially reflecting substantially the rest of the second light 130.

Embodiment VIII

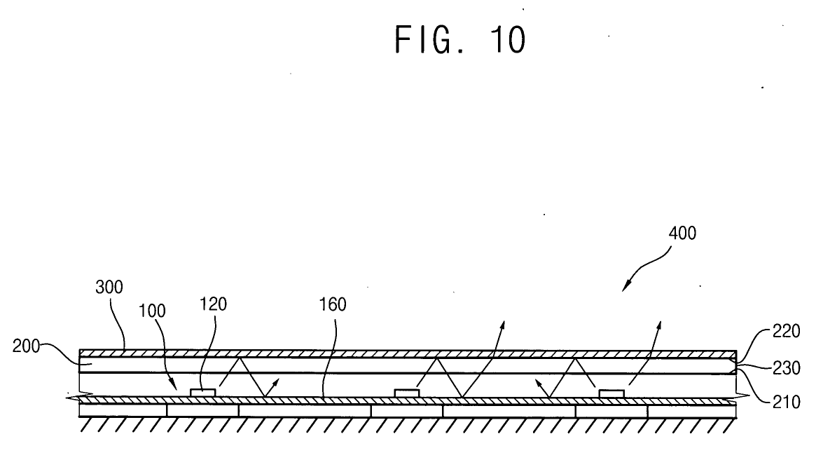

FIG. 10 is an exemplary diagram of a backlight assembly in accordance with an eighth embodiment of the present invention. Except for a reflective member, the backlight assembly is the same with the first embodiment of the present invention. Therefore, the same numerical references are used for the same member of the backlight assembly, and duplicated descriptions are omitted.

The light source assembly 100 further includes a reflective member 160 located in gaps between the light sources 120. Once a portion of the second light 130 is reflected by the transfiective member 300 and directed to the light source assembly 100, the reflective member 160 redirects the portion of the second light 130 back to the transflective member 300 to recycle the second light 130. Thus, the backlight luminescence and the luminance uniformity can be enhanced because more light is being mixed and transmitted by the transflective member 300.

According to the eighth embodiment, the reflective member 160 may be a plate with a polymeric reflecting layer such as a PolyEthylene Terephthalate (PET) or a highly reflective metal deposited or coated layer.

Embodiment IX

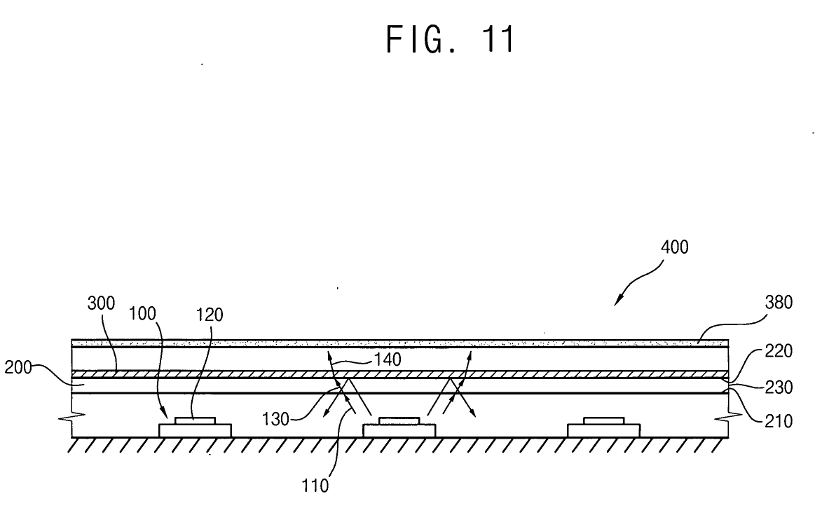

FIG. 11 is an exemplary diagram of a backlight assembly in accordance with a ninth embodiment of the present invention. Except for an optical member, the backlight assembly is the same with the first embodiment of the present invention. Therefore, the same numerical references are used for the same member of the backlight assembly, and duplicated descriptions are omitted.

The backlight assembly 400 further includes an optical member 380 located on or above the transflective member 300. For enhancing the luminance uniformity of the third light 140, the optical member 380 may include a diffuser, a prism sheet, or a brightness enhancement film so as to diffuse, collect and recycle the third light effectively.

Here, because the luminance uniformity of the third light 140 can be enhanced from the second light 130 by the transflective member 300, the gap between the optical members 380 and the transflective member 300 can be reduced, and finally, the whole backlight assembly 400 can be compact and light.

Hereinafter, the luminance uniformities in accordance to the distances between the light source 120, for example the bottom portion of the emission of the light source, and the optical member 380 are explained.

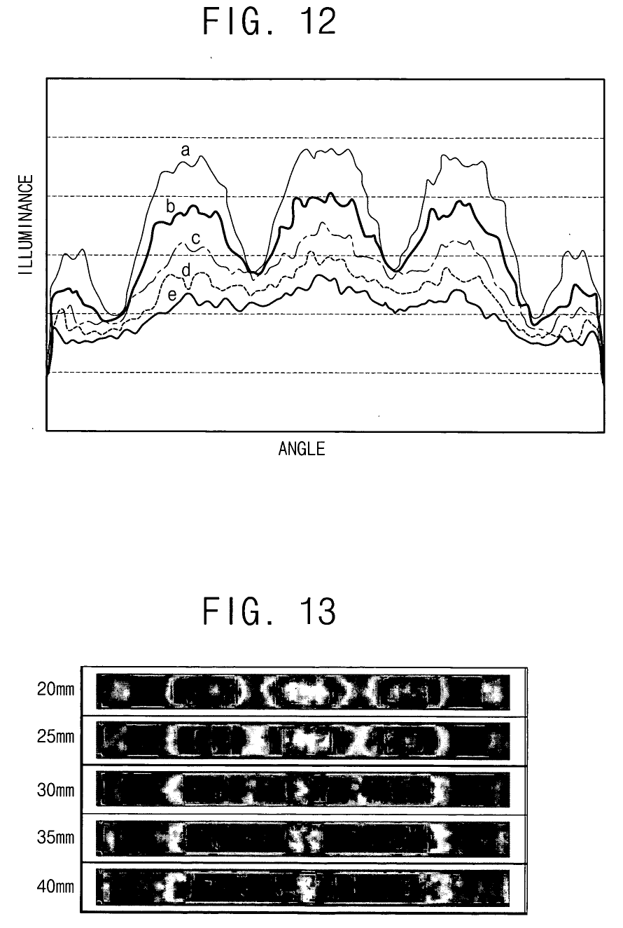

FIG. 12 is a luminance uniformity graph of a backlight assembly with different distances between a reflector and an optical member when no transflective member is present according to the ninth embodiment of the present invention. FIG. 13 is a plain view of luminance uniformity on the optical member of the FIG. 12.

In FIG. 12, curves a, b, c, d, and e show the luminescence as a function of angle when the light source 120 and the optical member 380 are respectively 20 mm, 25 mm, 30 mm, 35 mm, and 40 mm apart. As shown in FIG. 12 and FIG. 13, when no transflective member 300 is engaged, the luminance uniformity is significantly lower with the curves a-c, i.e., having a 20 to 30 mm gap between the light source 120 and optical members 380. As shown by curves d and e, the luminance uniformity of the backlight assembly 400 is higher over the angle span. Thus, as the gap between the light source and the optical member increases, the uniformity of the luminance or brightness increases.

As a result, without transflective member 300, more than a 30 mm gap between the light source 120 and the optical member 380 can result in higher display quality.

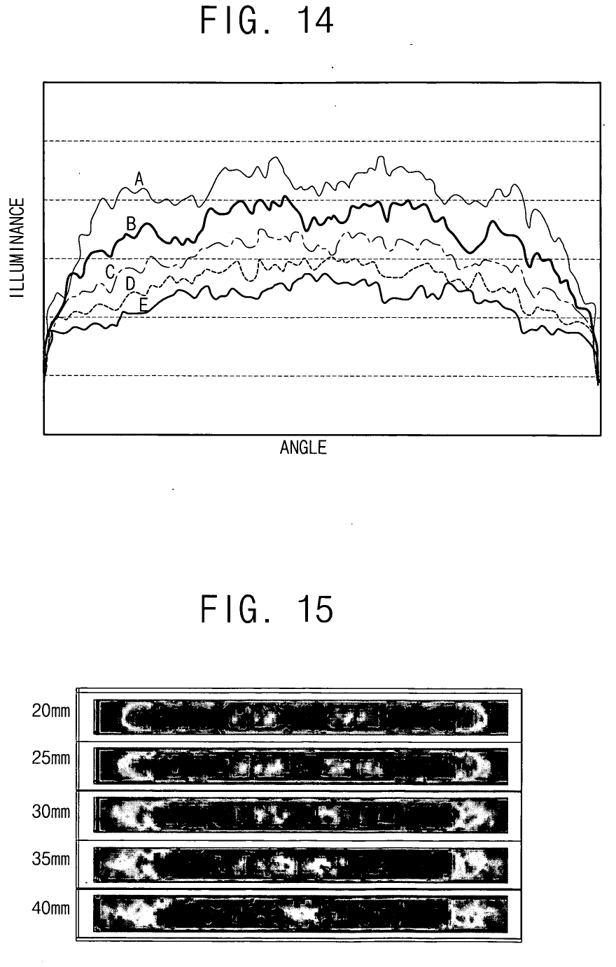

FIG. 14 is a luminance uniformity graph of a backlight assembly with different distances between a reflector and an optical member when a transflective member is present according to the ninth embodiment of the present invention. FIG. 15 is a plain view of luminance uniformity on the optical member of the FIG. 14.

In FIG. 14, curves A, B, C, D, and E show the luminescence as a function of angle when the light source 120 and the optical member 380 are respectively 20 mm, 25 mm, 30 mm, 35 mm, and 40 mm apart. As shown in FIG. 14 and FIG. 15, when the transflective member 300 is engaged, the luminance is relatively uniform any angle even when the gap between the light source 120 and the optical member 380 is 20 mm apart. Moreover, if the reflection/transmission ratio of the transflective member 300 is finely tuned, relatively uniform luminance can be acquired even when the gap is less than 20 mm.

As a result, by having transflective member 300, the third luminance uniformity is superior to the second luminance uniformity and the backlight assembly 400 can be compact and light by reducing the gap between the light source 120 and the optical members 380.

Display Device

Embodiment X

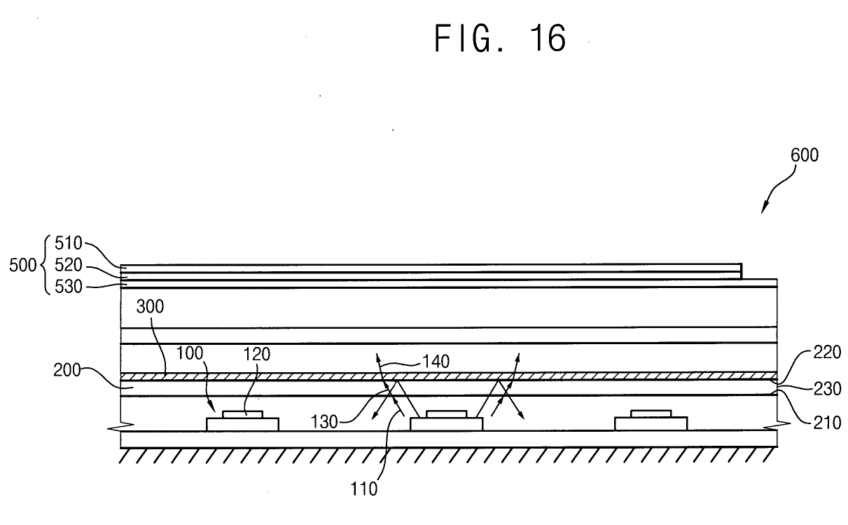

FIG. 16 is an exemplary diagram of a display device 600 in accordance with a tenth embodiment of the present invention. The display device 600 includes a backlight assembly 400 and a display panel 500. In the present embodiment, because the backlight assembly 400 is already explained in the prior embodiments, the same numerical references are used for the same member of the backlight assembly and duplicated descriptions are omitted.

The display panel 500 includes a first plate 530, a second plate 510, and a liquid crystal layer 520 located between the first and second plates. The first plate 530 includes a plurality of pixel electrodes, a plurality of thin film transistors (TFTS) for operating corresponding pixel electrodes, and signal lines for transferring signals to the TFTs. The pixel electrodes are made from transparent conductive material, such as Indium Tin Oxide (ITO), Indium Zinc Oxide (IZO), and amorphous Indium Tin Oxide (α-ITO).

The second plate 510 includes a transparent conductive common electrode and a plurality of color filters which face each corresponding pixel electrode of the first plate 530.

The liquid crystal layer 520 is interposed between two plates 510, 530 and rearranged by the current applied between the pixel electrode and the common electrode. Then, the amount of the light that passes through the liquid crystal layer 520 is changed by the liquid crystal molecule arrangement. Eventually, after passing through the color filter, the light becomes the image of the LCD.

As described above in detail, the transflective member recycles the light of the backlight assembly to have better luminance uniformity, and to make the backlight assembly compact and light.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

1. A backlight assembly, comprising:
a light source assembly having a light source and emitting a first light with a first luminance uniformity;
a substrate disposed above the light source assembly and having a first surface facing the light source and a second surface opposing the first surface, wherein the substrate receives the first light and emits a second light with a second luminance uniformity; and
a transflective member partially reflecting and partially transmitting the second light, wherein the light output from the transflective member has a third luminance uniformity higher than the first and second luminance uniformity.

2. The backlight assembly of claim 1, further comprising a power impression board disposed below the light source.

3. The backlight assembly of claim 1, further comprising a light guiding lens disposed at least partially over the light source, wherein the light guiding lens guides the first light within a range of angles between the first surface of the substrate and the light source.

4. The backlight assembly of claim 1, further comprising a light block disposed over the light source.

5. The backlight assembly of claim 1, wherein the light source is a light emitting diode.

6. The backlight assembly of claim 1, wherein the substrate is interposed between the transflective member and the light source assembly.

7. The backlight assembly of claim 1, further comprising a second transflective member between the light source and the substrate.

8. The backlight assembly of claim 1, wherein the transflective member comprises a reflection layer for partially reflecting the second light and a transmission layer for partially transmitting the second light.

9. The backlight assembly of claim 8, wherein the amount of the transmitted light and the reflected light is approximately inversely proportional.

10. The backlight assembly of claim 9, wherein the amount of the reflected light is approximately 70 to 90 percent and the amount of the transmitted light is approximately 10 to 30 percent of the total light directed to the transflective member.

11. The backlight assembly of claim 1, wherein the transflective member is disposed on the second surface of the substrate.

12. The backlight assembly of claim 1, wherein the transflective member comprises a bead located inside of the substrate.

13. The backlight assembly of claim 1, comprising a reflective member disposed between gaps of the light source.

14. The backlight assembly of claim 1, further comprising an optical member.

15. The backlight assembly of claim 14, wherein the optical member is at least one of a diffuser, a prism sheet, and a brightness enhancement film.

16. The backlight assembly of claim 14, wherein the distance between the optical member and the light source is approximately 40 mm or less.

17. A backlight assembly comprising:
a light source assembly emitting a first light with a first luminance uniformity;
a substrate disposed above the light source assembly and having a first surface facing the light source assembly and a second surface opposing the first surface, wherein the substrate receives the first light and emits a second light with a second luminance uniformity;
a transfiective member disposed over the second surface of the substrate for partially reflecting and partially transmitting the second light, wherein the transflective member reflects approximately 70 to 90 percent and transmits approximately 10 to 30 percent of the second light;
a light block between the light source and the substrate; and
an optical member disposed above the transflective member, wherein the optical member is at least one of a diffuser, a prism sheet, and a brightness enhancement film.

18. A display device comprising:
a backlight assembly, comprising:
a light source assembly emitting a first light with a first luminance uniformity;
a substrate receiving the first light and emitting a second light with a second luminance uniformity higher than the first luminance uniformity; and
a transfiective member partially reflecting and partially transmitting the second light, wherein light from the transflective member has a third luminance uniformity higher than the second luminance uniformity; and
a display panel for displaying images by receiving the third light from the transflective member.

19. The display device of claim 18, wherein the transflective member is disposed on a first surface of the substrate, the first surface facing the light source assembly.

20. The display device of claim 18, wherein the substrate is interposed between the light source assembly and the transflective member.

21. The display device of claim 18, wherein the reflective ratio of the transfiective member is approximately 70 to 90 percent and the transmissive ratio of the transflective member is approximately 10 to 30 percent.

22. A method of operating a backlight assembly, the method comprising:
emitting a first light;
receiving the first light by a substrate with a first surface;
emitting a second light from a second surface of the substrate, wherein the second light has higher luminance uniformity than the first light;
partially reflecting the second light; and
partially transmitting the second light having a luminance uniformity higher than the second light.

23. The method of operating a backlight assembly of claim 22, wherein approximately 70 to 90 percent of the second light is reflected and approximately 10 to 30 percent of the second light is transmitted.

24. A method of manufacturing a backlight assembly, the method comprising:
providing a light source assembly at the lower side of the backlight assembly;
disposing a substrate above the light source assembly; and
placing a transflective member over the substrate, wherein the transfiective member reflects approximately 70 to 90 percent and transmits approximately 10 to 30 percent of the incident light.
